(19) United States
(12) Patent Application Publication
(10) Pub. No.: US 2026/0226950 A1
(43) Pub. Date: Aug. 6, 2026

(54) CLUTCH STRUT EARS, EAR SLEEVES, AND COUPLINGS

(71) Applicant: Means Industries, Inc., Saginaw, MI (US)

(72) Inventor: Riley Moore, Flint, MI (US)

(21) Appl. No.: 19/450,841

(22) Filed: Jan. 16, 2026

Related U.S. Application Data
(60) Provisional application No. 63/753,521, filed on Feb. 4, 2025.

(51) Int. Cl. F16D 41/12

(52) U.S. Cl. CPC F16D 41/125

(57) ABSTRACT

A planar torque-transmitting coupling includes a planar pocket plate including a pocket surface having a strut pocket, and a planar strut carried in the strut pocket of the pocket surface of the planar pocket plate, and extending along a longitudinal axis and pivotable about a pivot axis transverse with respect to the longitudinal axis, and including ears that extend along the pivot axis and that have cylindrical outer surfaces. A torque-transmitting coupling planar strut pivotable about a pivot axis, includes a body and ears extending outwardly from the body and have cylindrical outer surfaces establishing the pivot axis. A clutch strut ear sleeve includes sidewalls establishing a cylindrical inner surface.

### TECHNICAL FIELD

This disclosure relates generally to torque-transmitting couplings and, more particularly, to pivotable pawls or struts used in such couplings.

### BACKGROUND

Torque-transmitting couplings include, for example, radial overrunning clutches and planar overrunning clutches. A typical planar overrunning clutch includes a planar pocket plate including a planar pocket face having circumferentially spaced pockets therein, and a planar notch plate including a planar notch face facing the planar pocket face of the planar pocket plate and having circumferentially spaced notches therein. The typical planar overrunning clutch also includes pivotable struts carried in the strut pockets of the planar pocket plate and pivotable into and out of engagement with the notches of the planar notch plate to engage and disengage the planar notch plate with respect to the planar pocket plate, and strut springs to either bias the struts outward toward engagement with the planar notch plate or bias the struts inward away from engagement with the planar notch plate. A typical strut extends along a longitudinal axis and is pivotable about a pivot axis transverse to the longitudinal axis. The typical strut includes faces, sides, ends extending transversely with respect to the longitudinal axis, and ears extending away from the sides and having non-cylindrical geometry with beveled edges establishing the pivot axis.

Although such planar overrunning clutches and struts are commercially successful, improvements remain desirable. For instance, typical planar strut designs are intended for use in static clutches and are not well adapted for use in dynamic clutches as they would not function well or would not be durable. In some dynamic one way clutches, a planar strut is retained at a radially outer wall of a pocket in a pocket plate and relies on a combination of a precise wall draft angle and spring force to achieve strut actuation at a desired rotational speed of the clutch. Unfortunately, however, after many service hours of overrunning, the radially outer wall of the strut pocket may begin to wear away the precise wall draft angle and lead to degradation of clutch performance. More specifically, such degradation may lead to out-of-specification strut “laydown” speed, which is that minimum angular velocity of the planar pocket plate at which the strut remains seated within the strut pocket. Strut laydown prevents damage to the strut and to the pocket and notch plates that would otherwise result from the strut bouncing in and out of the strut pocket, and also minimizes “windage” and other parasitic losses in efficiency. In other dynamic one way clutches, a planar strut is retained at its polygonal ears instead of at the radially outer wall of the strut pocket, thereby addressing the problem described above. But such struts are dynamic non-overrunning struts and are not well suited for use as dynamic overrunning struts. This is because the polygonal ears incur corner collisions during overrunning, thereby leading to premature wear. And the polygonal ears limit predictability of strut laydown because reaction forces and frictional interactions between the strut and the pocket plate are not consistent over the range of motion of the strut.

### SUMMARY

According to an embodiment of a planar torque-transmitting coupling, the coupling includes a planar pocket plate including a pocket surface having a strut pocket, and a planar strut carried in the strut pocket of the pocket surface of the planar pocket plate, and extending along a longitudinal axis and pivotable about a pivot axis transverse with respect to the longitudinal axis, and including ears that extend along the pivot axis and that have cylindrical outer surfaces.

According to an embodiment of a torque-transmitting coupling planar strut pivotable about a pivot axis, the strut includes a body and ears extending outwardly from the body and have cylindrical outer surfaces establishing the pivot axis.

According to an embodiment of a clutch strut ear sleeve, the sleeve includes sidewalls establishing a cylindrical inner surface.

According to another embodiment of a planar torque-transmitting coupling, the coupling includes a planar pocket plate including a pocket surface having a strut pocket, and a planar strut carried in the strut pocket of the pocket surface of the planar pocket plate, and extending along a longitudinal axis and pivotable about a pivot axis transverse with respect to the longitudinal axis, and including ears that extend along the pivot axis and that have cylindrical outer surfaces. The ears include a radially outer ear having a radially outer tip in contact with a corresponding outer ear bearing surface of the strut pocket to retain the planar strut in a radial direction when the planar pocket plate rotates and the planar strut experiences a centrifugal force, and a radially inner ear having a radially inner front surface in contact with a corresponding inner ear bearing surface of the strut pocket to retain the planar strut in a torsional direction when the planar pocket plate rotates and the planar strut experiences the centrifugal force. At least one of the ears has an excurvate tip. The coupling also includes a planar notch plate including a notch surface having notches circumferentially spaced from one another and facing the pocket surface of the planar pocket plate, wherein the planar strut is engageable with the notches to transmit torque between the planar pocket plate and the planar notch plate.

According to a further embodiment of a planar torque-transmitting coupling, the coupling includes a planar pocket plate including a pocket surface having a strut pocket, and a planar strut carried in the strut pocket of the pocket surface of the planar pocket plate, and extending along a longitudinal axis and pivotable about a pivot axis transverse with respect to the longitudinal axis, and including ears that extend along the pivot axis and that have cylindrical outer surfaces. The coupling also includes at least one ear sleeve carried on at least one of the ears of the planar strut, and having sidewalls establishing a cylindrical inner surface in which at least one of the cylindrical outer surfaces of the ears are carried. The at least one ear sleeve includes a radially outer ear sleeve having a radially outer tip in contact with a corresponding outer ear bearing surface of the strut pocket to retain the planar strut in a radial direction when the planar pocket plate rotates and the planar strut experiences a centrifugal force, and a radially inner ear sleeve having a radially inner front surface in contact with a corresponding inner ear bearing surface of the strut pocket to retain the planar strut in a torsional direction when the planar pocket plate rotates and the planar strut experiences the centrifugal force. At least one of the at least one ear sleeves has an excurvate tip. The coupling also includes a planar notch plate including a notch surface having notches circumferentially spaced from one another and facing the pocket surface of the planar pocket plate, wherein the planar strut is engageable with the notches to transmit torque between the planar pocket plate and the planar notch plate.

### BRIEF DESCRIPTION OF THE DRAWINGS

FIG. 1 is a perspective cross-sectional view according to an illustrative embodiment of a novel planar torque-transmitting coupling including a planar notch plate, a novel planar pocket plate, novel planar struts carried by the planar pocket plate, a cover plate carried by the planar pocket plate, and a retaining ring carried by the planar notch plate to retain the planar pocket plate to the planar notch plate.

FIG. 2 is a perspective view of the planar notch plate of FIG. 1, illustrating a circumferential array of notches in a notch surface of the planar notch plate.

FIG. 3 is a perspective view of the planar pocket plate of FIG. 1, illustrating circumferential arrays of teeter-totter pockets and T pockets in a pocket surface of the planar pocket plate.

FIG. 3A is an enlarged fragmentary perspective view of a teeter-totter pocket of FIG. 3.

FIG. 3B is an enlarged fragmentary perspective view of a T pocket of FIG. 3.

FIG. 4 is a perspective view of the cover plate of FIG. 1, illustrating circumferential arrays of apertures through the cover plate.

FIG. 5 is an enlarged perspective view of a teeter-totter strut of the coupling of FIG. 1.

FIG. 6 is an enlarged cross-sectional view of the teeter-totter strut of FIG. 5 carried in a corresponding teeter-totter pocket of the planar pocket plate of FIG. 3, partially covered by the cover plate, and biased by a spring carried in a spring portion of the teeter-totter pocket.

FIG. 7A is an enlarged fragmentary plan view of the coupling of FIG. 1, illustrating the teeter-totter strut carried in the corresponding teeter-totter pocket of the planar pocket plate of FIG. 3, and partially covered by the cover plate of FIG. 4.

FIG. 7B is a schematic plan view of the teeter-totter strut and its corresponding teeter-totter pocket in the form of a force diagram illustrating forces when the planar pocket plate rotates and the planar struts experience a centrifugal force.

FIG. 8 is an enlarged perspective view of a T strut of the coupling of FIG. 1.

FIG. 9 is an enlarged cross-sectional view of the T strut of FIG. 8 carried in a corresponding T pocket of the planar pocket plate of FIG. 3, partially covered by the cover plate, and biased by a spring carried in a spring portion of the T pocket.

FIG. 10A is an enlarged fragmentary plan view of the coupling of FIG. 1, illustrating the T strut carried in the corresponding T pocket of the planar pocket plate of FIG. 3, and partially covered by the cover plate of FIG. 4.

FIG. 10B is a schematic plan view of the T strut and its corresponding T pocket in the form of a force diagram illustrating forces when the planar pocket plate rotates and the planar struts experience a centrifugal force.

FIG. 11 is a fragmentary upper perspective view of the planar pocket plate of FIG. 3, illustrating another embodiment of a teeter-totter strut including ears and ear sleeves carried on the ears.

FIG. 11A is an enlarged fragmentary cross-sectional view of one of the ears and its corresponding ear sleeve of FIG. 11.

FIG. 12 is an enlarged rear perspective view of one of the ear sleeves of FIG. 11.

FIG. 12A is an enlarged front perspective view of the ear sleeve of FIG. 12.

### DETAILED DESCRIPTION

In general, novel planar struts will be described using one or more examples of illustrative embodiments of a novel torque-transmitting coupling that includes a planar notch plate and a novel planar pocket plate that can be coupled to the planar notch plate via the struts. The example embodiments will be described with reference to use of the novel planar struts, planar pocket plate, and torque-transmitting coupling for clutches, park locks, brakes, and the like. However, it will be appreciated as the description proceeds that the novel planar struts, planar pocket plate, and torque-transmitting coupling are useful in many different applications and may be implemented in many other embodiments.

Each of the planar struts extends along a longitudinal axis, is pivotable about a pivot axis transverse to the longitudinal axis, and includes faces, sides, ends, and inner and outer ears extending in a direction away from the sides and having cylindrical outer surfaces and terminating in excurvate tips. The planar struts are retained in strut pockets of the planar pocket plate, and the ears are retained in corresponding ear pockets of the strut pockets. The planar struts are configured in conjunction with the strut pockets such that when the pocket plate is rotating and the struts experience centrifugal forces, the struts are retained in a radial direction by contact of the excurvate tips of the outer ears with the pocket plate and are retained in a twisting or torsional direction by contact of fronts of the inner ears with the pocket plate. The cylindrical outer surfaces facilitate smooth rotation of the planar struts while the ears are contacting corresponding portions of ear pockets, with reaction forces and frictional interactions between the strut and the pocket plate remaining consistent over the range of motion of the strut, thereby leading to more predictable strut laydown compared to struts with polygonal ears. The cylindrical outer surfaces also avoid corner collisions as the strut rotates through its range of motion during overrunning, thereby improving durability of the dynamic overrunning strut compared to struts with polygonal ears. The excurvate tips may be unitary with the cylindrical outer surfaces of the ears, or may be unitary with ear sleeves separate from the strut and carried by the cylindrical outer surfaces of the ears.

In contrast to current devices where sides of planar struts are configured to be in contact with relatively large, sensitive, and precisely drafted pocket walls of a pocket plate, the excurvate tips of the presently disclosed strut are configured to be in contact with relatively small, robust, and simple discrete areas of ear pockets of the planar pocket plate. Relocation of such contact interfaces facilitates a more consistent strut laydown speed as the components wear in, because the precise angle and shape of the relocated contact interface has lesser effect on the strut laydown speed. Such relocation curtails the wear problem described in the background section, because it helps prevent extreme wear that tends to result from an excessively high strut laydown speed. The excurvate tip may beneficially reduce frictional resistance compared to a completely blunt tip, and it also improves predictability of strut motion because it allows the pivot axis of the strut to be more consistently located over varying strut orientations.

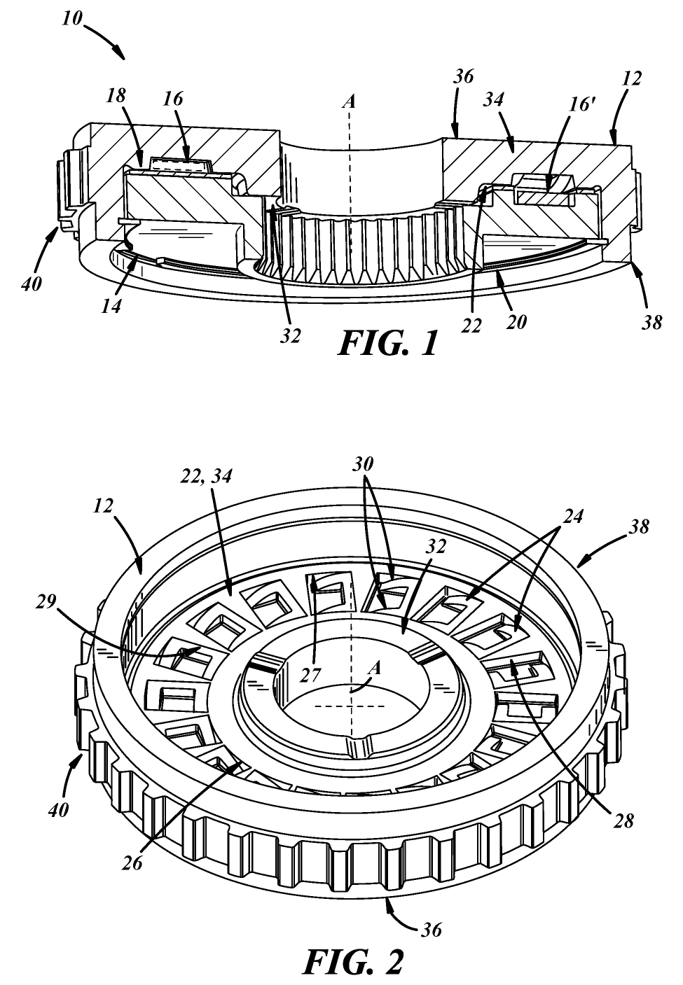

Referring specifically to the drawings, FIG. 1 shows an illustrative embodiment of a planar torque-transmitting coupling 10, which may be a clutch, a park lock, a brake, or any other coupling suitable to transmit torque from one component to another. Accordingly, as used herein, the terminology “torque-transmitting” includes dynamic torque transmission among rotating components, static torque carrying among non-rotating components, and the like. The coupling 10 includes a planar notch plate 12, a planar pocket plate 14, and one or more planar struts 16 (shown schematically), 16’ carried by the planar pocket plate 14 and engageable with the planar notch plate 12. The coupling 10 also may include a cover plate 18 to retain the planar struts 16, 16’ with respect to the planar pocket plate 14. The coupling 10 further may include a retainer 20 to retain the planar pocket plate 14 with respect to the planar notch plate 12 and may include a retaining ring, for example, a snap ring. The planar notch plate 12 and the planar pocket plate 14 are not necessarily strictly planar-shaped individual components, although they could be, and instead may be planar portions of larger components or assemblies that are otherwise not necessarily planar in overall shape. In that regard, the term “planar” as used in conjunction with torque-transmitting couplings, notch plates, pocket plates, and struts is used in contrast to the term “radial” used in conjunction with the aforementioned products. For example, planar notch plates and pocket plates may include flat disc-like components, whereas radial notch plates and pocket plates may include annular race-like components.

With reference to FIGS. 1 and 2, the planar notch plate 12 includes a notch surface 22 having notches 24 circumferentially spaced from one another, for example, in an equidistantly spaced circumferential array of the notches 24. The notches 24 may include radially inward and outward sides 26, 27 that are radially opposed to one another, circumferentially forward and rearward ends 28, 29 extending radially between the sides 26, 27, and strut ramps 30 extending circumferentially and axially away from the ends 28, 29. As used herein, terms like “circumferential” and “radial” and their variants do not necessarily mean perfectly circumferential and perfectly radial and the like, and, instead, also includes relatively circumferential and relatively radial and the like. Moreover, directional words such as front, rear, top, bottom, upper, lower, radial, circumferential, axial, lateral, longitudinal, vertical, horizontal, transverse, and/or the like are employed by way of example and not necessarily limitation. Also, the planar notch plate 12 may include a hub 32 that may have an inner diameter surrounding a rotational axis A of the planar notch plate. The planar notch plate 12 also may include a planar wall 34 extending radially outwardly from the hub 32 and having a base surface 36 and the notch surface 22 axially oppositely disposed from the base surface 36. The planar notch plate 12 also may include an annular wall 38 that may extend in a direction axially away from the planar wall 34.

With continued reference to FIG. 1, the annular wall 38 may have an inner diameter to receive the cover plate 18 radially therein and the planar pocket plate 14 therein and radially retain the cover plate 18 and the planar pocket plate 14 with respect to the planar notch plate 12. The annular wall 38 also may include an annular groove in the inner diameter to receive the retainer 20 that axially retains the cover plate 18 and the planar pocket plate 14 between the retainer 20 and the planar wall 34 of the planar notch plate 12. The annular wall 38 further may include an outer diameter including splines 40 that may be used to circumferentially retain the planar notch plate 12 with respect to some other structure, for example, a transmission housing, an axle housing, or some other drivetrain housing or component. In the illustrated embodiment, the planar notch plate 12 may be a driven component or a reaction component that may be acted upon by torque imparted to it by the planar pocket plate 14. In other embodiments, the planar notch plate 12 may be a rotatable component, for example, configured to be rotatably driven by the planar pocket plate 14, and coupled to a rotatable shaft or other component, for example, via a splined or welded connection therewith, unitary integration therewith, or any other suitable coupling.

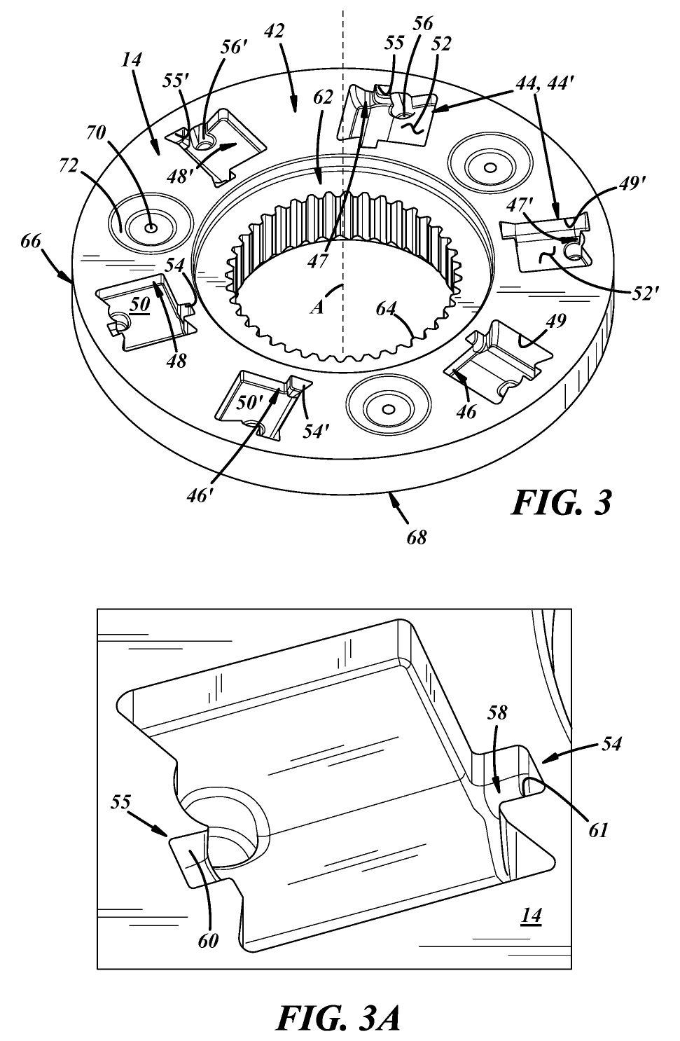

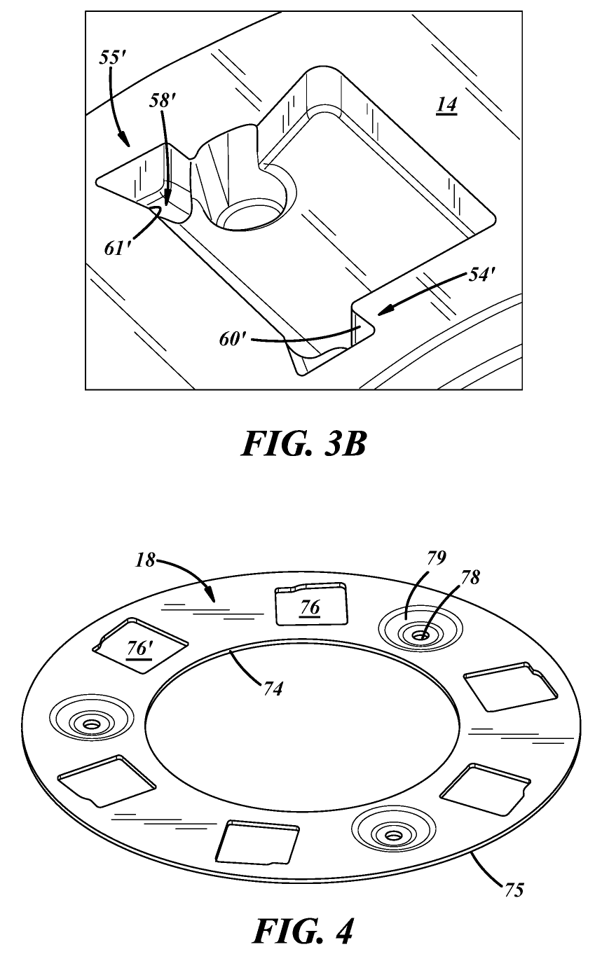

With reference to FIGS. 1 and 3, the planar pocket plate 14 includes a pocket surface 42 establishing one or more strut pockets 44, 44’ to contain the struts 16, 16’ and circumferentially spaced from one another. For example, the strut pockets 44, 44’ may include a circumferential array of first strut pockets 44 that may be equidistantly spaced from one another, and/or a circumferential array of second strut pockets 44’ that may be equidistantly spaced from one another and circumferentially interspersed with the first strut pockets 44. Although the illustrated embodiment shows two different sets of strut pockets 44, 44’, it is contemplated that one or the other sets of strut pockets 44, 44’ would be used in any given application. The first strut pockets 44 may be “teeter-totter” pockets to carry “teeter-totter” struts, and the second strut pockets 44’ may be “T” pockets to carry “T” struts. Accordingly, the planar struts 16, 16’ may include a circumferential array of first planar struts 16 that may be equidistantly spaced from one another, and a circumferential array of second planar struts 16’ that may be equidistantly spaced from one another and circumferentially interspersed with the first planar struts 16. Although the illustrated embodiment shows two different sets of struts 16, 16’, it is contemplated that one or the other sets of struts 16, 16’ would be used in any given application. Those of ordinary skill in the art would recognize that the teeter-totter struts 16 may be passively actuated as shown in the illustrated embodiment (or passively deactuated in other embodiments) with one or more springs 57 (FIG. 6) disposed between the struts 16 and the pocket plate 14, or may be actively actuated with plungers such as rods or springs, or any other suitable actuation elements that may be actuated electromagnetically, hydraulically, mechanically or in any other suitable manner by any suitable actuator(s) (not shown). Furthermore, the struts 16 may be passively or actively actuatable to an on or engaged position, or may be passively or actively actuatable to an off or disengaged position. The planar struts 16, 16’ are deployable with respect to the strut pockets 44, 44’ of the pocket plate 14, as will be further discussed herein below, to deployed positions of the struts 16, 16’ wherein the struts 16, 16’ are engageable with the notches 24 of the planar notch plate 12 to transmit torque between the planar pocket plate 14 and the planar notch plate 12.

With continued reference to FIGS. 1 and 3, the strut pockets 44, 44’ of the illustrated embodiment may include depressions below or in the pocket surface 42. In other embodiments, the strut pockets 44, 44’ may include projections above or on the pocket surface 42. In any case, the strut pockets 44, 44’ may include radially inner sides 46, 46’ and radially outer sides 47, 47’ that may be radially opposed to one another, circumferentially forward ends 48, 48’ that may extend in a direction between the sides 46, 46’ 47, 47’ and circumferentially rearward ends 49, 49’ that may extend in a direction between the sides 46, 47, 46’, 47’, and bottoms 50, 50’ that may extend in directions between the sides and ends 46-49, 46’-49’. Accordingly, at least in the illustrated embodiment, the first and second strut pockets 44, 44’ (and, likewise, the struts 16, 16’ carried therein) are all configured to be oriented in the same circumferential direction. The strut pockets 44, 44’ further include strut body pockets 52, 52’ that may be oblong and that may extend longitudinally, and inner and outer ear pockets 54, 54’, and 55, 55’ extending transversely with respect to the strut body pockets 52, 52’. The strut body pockets 52, 52’ may establish the sides 46, 46’, 47, 47’, ends 48, 48’, 49, 49’, and bottoms 50, 50’. The strut pockets 44, 44’ also include spring pockets 56, 56’ in the bottoms 50, 50’. The strut body pockets 52, 52’ may include triangular reliefs between the side and ends, for example, to prevent strut ear loading while carrying torque and/or to provide an increased corner radius to reduce stress on the pocket plate 14. With reference now to FIGS. 3A and 3B, each of the strut ear pockets 54-55’ may include bottom surfaces 58, 58’ that may be semi-cylindrically shaped, or flat with adjacent fillets that may be of relatively large radius, and forward and rearward ends 60, 61, 60’, 61’ that extend away from the bottom surfaces 58, 58’ and that may be flat. The rearward (or reaction) ends 49, 49’ may be incurvate or may have incurvate portions.

Also, with continued reference to FIG. 3, the planar pocket plate 14 may include a hub 62 that may have an inner diameter surrounding a rotational axis A of the planar pocket plate 14 and that may be splined to have splines 64 for connection to some other component, for example, a rotatable shaft or other component. The planar pocket plate 14 also may include a planar wall 66 extending radially outwardly from the hub 62 and having a base surface 68 and the pocket surface 42 axially oppositely disposed from the base surface 68. With brief reference again to FIG, 1, the planar wall 66 may have an outer diameter received radially within the annular wall 38 of the planar notch plate 12. The planar pocket plate 14 illustrated in FIG. 3 also includes fastener passages 70 that may be equidistantly spaced in a circumferential array to accept shafts of fasteners (not shown) therethrough, and fastener dimples 72 surrounding the fastener passages 70 to accommodate heads of the fasteners (not shown). In the illustrated embodiment shown in FIG. 1, the planar pocket plate 14 may be rotatably driven by torque imparted to it by the planar notch plate 12 via the planar struts 16, 16’. Accordingly, the coupling 10 of the illustrated embodiment is preferably a dynamic coupling. In a specific example, when the coupling 10 is used in an upshift configuration, for example, a 1-2 upshift from a first gear to a second gear, rotation of the planar notch plate 12 may slow down and rotation of the planar pocket plate 14 may speed up with increasing vehicle speed. In the higher gear, for example, second gear, the struts 16 lay down and the coupling 10 is overrunning. In other embodiments, the planar pocket plate 14 may be a drive component of the planar torque-transmitting coupling 10 and configured to receive drive torque from a shaft (not shown) splined to the splined hub 62 and transmit the drive torque to the planar notch plate 12 via the planar struts 16, 16’. But it is also contemplated that the coupling 10 could be configured in another embodiment such that the planar pocket plate 14 or, alternatively, the planar notch plate 12, may be configured to be circumferentially fixed with respect to a housing or some other component.

With reference to FIGS. 1 and 4, the cover plate 18 in the illustrated embodiment is a single unitary component but, in other embodiments, may include a plurality of sector-shaped components. The illustrated cover plate 18 includes a radially inner cylindrical surface 74, a radially outer cylindrical surface 75, and a circumferential array of first apertures 76 that may be equidistantly spaced from one another, and a circumferential array of second apertures 76’ that may be equidistantly spaced from one another. The apertures 76, 76’ may be in circumferential and radial registration with the corresponding strut pockets 44, 44’ (FIG. 3) in the assembled coupling 10 (FIG. 1). The illustrated cover plate 18 also includes a circumferential array of fastener passages 78 that may be equidistantly spaced and that accept shafts of fasteners (not shown) therethrough, and fastener dimples 79 surrounding the fastener passages 78 to accept heads of the fasteners (not shown).

With continued reference to FIG. 1, and although not separately shown, the fasteners may include screws having heads seated in the fastener dimples and threaded shafts extending from the upset heads, through the fastener passages of the cover plate 18, and into the corresponding threaded passages of the planar pocket plate 14. Of course, rivets or any other fasteners suitable to fasten the cover plate 18 to the planar pocket plate 14 may be used. The cover plate 18 may be used for retaining the planar struts 16, 16’ within the strut pockets 44, 44’ of the planar pocket plate 14 and preventing strut ears (and elongated rear ends of “teeter-totter” struts) from contacting the planar notch plate 12.

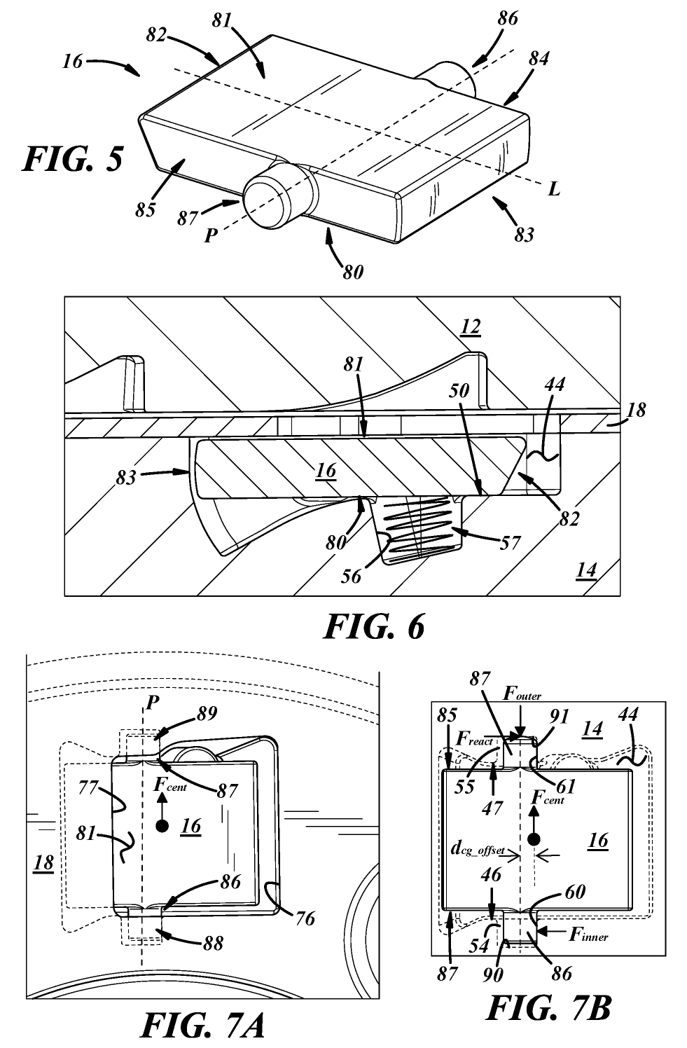

With reference now to FIG. 5, one of the “teeter-totter” struts 16 is shown and extends along a longitudinal axis L and is pivotable about a pivot axis P that extends transversely with respect to the longitudinal axis L. The planar strut 16 includes a body with inner and outer faces 80, 81 that may extend parallel to, or at least along, the longitudinal axis L, and longitudinal forward and rearward ends 82, 83 extending in a direction between the inner and outer faces 80, 81 and transversely to the longitudinal axis L. The body of the strut 16 also includes inward and outward sides 84, 85 extending in a direction between the inner and outer faces 80, 81 and between the longitudinal forward and rearward ends 82, 83. The faces 80, 81 may face in opposite directions, the ends 82, 83 may face in opposite directions, and the sides 84, 85 may face in opposite directions such that the struts 16 may be prismatic, although the struts 16 need not be strictly rectangular prismatic. The strut 16 may be oblong in that it may be greatest in dimension along the longitudinal axis L and may be thin in that it is greater in length and width than it is in thickness between the faces 80, 81.

With continued reference to FIG. 5, the strut 16 further includes inner and outer ears 86, 87 extending outwardly from the body of the strut 16 in a direction away from the inward and outward sides 84, 85 and having cylindrical outer surfaces that at least partially establish the pivot axis P of the strut 16. The cylindrical outer surfaces of the inner and outer ears 86, 87 may be cylindrical over 360 angular degrees, or cylindrical at least over circumferential portions thereof that contact corresponding surface(s) of the corresponding ear pockets 54, 55 of the corresponding strut pockets 44 (FIG. 3). For example, the cylindrical outer surfaces may be cylindrical over at least twenty angular degrees about the pivot axis P for struts that have a twenty angular degree range of motion in operation of the coupling 10, or at least thirty angular degrees about the pivot axis P for struts that have a thirty angular degree range of motion in operation of the coupling 10, or between ten and forty-five angular degrees for struts that have a range of motion between ten and forty-five angular degrees in operation of the coupling 10, and the like. The cylindrical outer surfaces may be continuously cylindrical over the particular range, or may be interrupted with gaps but do not have any projections, edges, or the like that extend radially outward of the cylindrical outer surface over the particular range. Accordingly, the cylindrical outer surfaces are in contrast to prior art ears that are either non-cylindrical or partially cylindrical but bordered by flats, shoulders, and/or edges that contact corresponding portion(s) of a prior art pocket plate. Also, in contrast to prior art ears, at least the outer ears 87 terminate in tips that may have excurvate surfaces, such that the tips may be excurvate tips. An ear tip may be continuously excurvate in a direction extending radially inwardly from the cylindrical outer surface. In other embodiments, an ear tip may be flat at a central portion thereof and then excurvate from the flat central portion to the cylindrical outer surface. In that case, the flat central portion covers no more than 50% of an overall diameter of the cylindrical outer surface. The term “excurvate” includes rounded, semi-spherical, hemi-spherical, parabolic, hyperbolic, and other like excurvate shapes.

With reference now to FIG. 6, the inner and outer faces 80, 81 may be flat. Also, the longitudinal rearward (reaction) end 83 may be excurvate in a direction between the faces 80, 81 in conformity with the corresponding incurvate shaped surface of the rearward end 49 of the strut pocket 44 of the planar pocket plate 14 (FIG. 3). Further, the longitudinal forward (engagement) end 82 may be obliquely angled in a direction between the faces 80, 81, wherein an acute angle is formed by the outer face 81 and the forward end 82. The forward end 82 may be flat over a predominant portion thereof but with a rounded nose that transitions the forward end 82 to the outer face 81. The inner face 80 is illustrated resting on a flat portion of the bottom 50 of the strut pocket 44 of the planar pocket plate 14, wherein the forward end 82 of the strut 16 is disposed within the strut pocket 44 and does not extend out of the strut pocket 44, such that the strut 16 is in its laydown position within the strut pocket 44. FIG. 6 illustrates a deployment spring 57 carried in the corresponding spring pocket 56 to bias the strut 16 in an outward direction toward the notch plate 12.

With reference now to FIG. 7A, the strut 16 is pivotable about its pivot axis P, which may be established by the cylindrical outer surfaces of the ears 86, 87 of the strut 16. The strut ears 86, 87 may be spaced from the longitudinal rearward end 83 of the strut 16, but located closer to the rearward end 83 of the strut 16 than to the forward end 82 of the strut 16, such that the strut ears 86, 87 are relatively proximate to the rearward end 83 and relatively distal from the forward end 82. The cover plate 18 has ear covering portions 88, 89 corresponding to the ears 86, 87 to retain the ears 86, 87 in the ear pockets 54 of the pocket plate 14 (FIG. 3). Additionally, in this embodiment, the corresponding aperture 76 of the cover plate 18 has a rearward edge 77 that may block a rearward portion of the strut 16 from contacting the notch plate during clutch overrunning (FIG. 6).

With reference now to FIG. 7B, the strut 16 is carried within the strut pocket 44 according to one or more following examples configured to address the problems identified in the background. In a first example, a radial gap is provided between the corresponding sides 47, 85 of the strut pocket 44 and the strut 16, wherein the outward side 85 of the strut 16 does not contact the outer side 47 of the strut pocket 44, such that the outer side 47 of the strut pocket 44 does not bear a centrifugal load of the strut 16. In a second example, the cylindrical outer surfaces of the inner and outer ears 86, 87 of the strut 16 contact corresponding forward end surfaces 60, 61 of the strut pocket 44 at least when the strut 16 is in its laydown position in the strut pocket 44, and such that the strut 16 is pivotable about the cylindrical outer surfaces of the inner and outer ears 86, 87. In a third example, a radial gap is provided between the corresponding sides 46, 84 of the strut pocket 44 and the strut 16, wherein the inward side 84 of the strut 16 does not contact the inner side 46 of the strut pocket 44. In a fourth example, a radial gap is provided between the tip of the inner ear 86 of the strut 16 and a corresponding side 90 of the strut pocket 44, wherein the tip of the inner ear 86 of the strut 16 does not contact the corresponding side 90 of the strut pocket 44. In a fifth example, there is no radial gap provided between the tip of the outer ear 87 of the strut 16 and a corresponding side 91 of the strut pocket 44, wherein the tip of the outer ear 87 of the strut 16 does indeed contact the corresponding side 91 of the strut pocket 44, such that the corresponding side 91 of the strut pocket 44 bears a centrifugal load of the strut 16 when the pocket plate 14 rotates.

As a result, and with continued reference to FIG. 7B, when the pocket plate 14 rotates, the strut 16 experiences a centrifugal force F_centrifugal that pushes the strut 16 radially outward. The strut 16 is retained in a radially outward direction by an outer force F_outer on the tip of the outer ear 87 at the corresponding side 91 of the outer ear pocket 55. An offset distance d_cg_offset, between a center of gravity (black dot) of the strut 16 and a reaction point between the tip of the outer ear 87 and the corresponding side 91 of the outer ear pocket 55, creates a torsional moment on the strut 16 that is reacted by an inner force F_inner on the inner ear 86 at the corresponding forward end surface 60 of the inner ear pocket 54 that prevents the outward side 85 of the strut 16 from contacting the outer side 47 of the strut pocket 44. Additionally, but less importantly, there is a lateral reaction force F_reaction that may take several forms, such as a frictional force (as shown) at the reaction point between the tip of the outer ear 87 and the corresponding side 91 of the outer ear pocket 55, or a normal contact force (not shown) at a rear outer corner of the strut 16 or, less desirably, a normal contact force (not shown) at a rear of the outer ear 87.

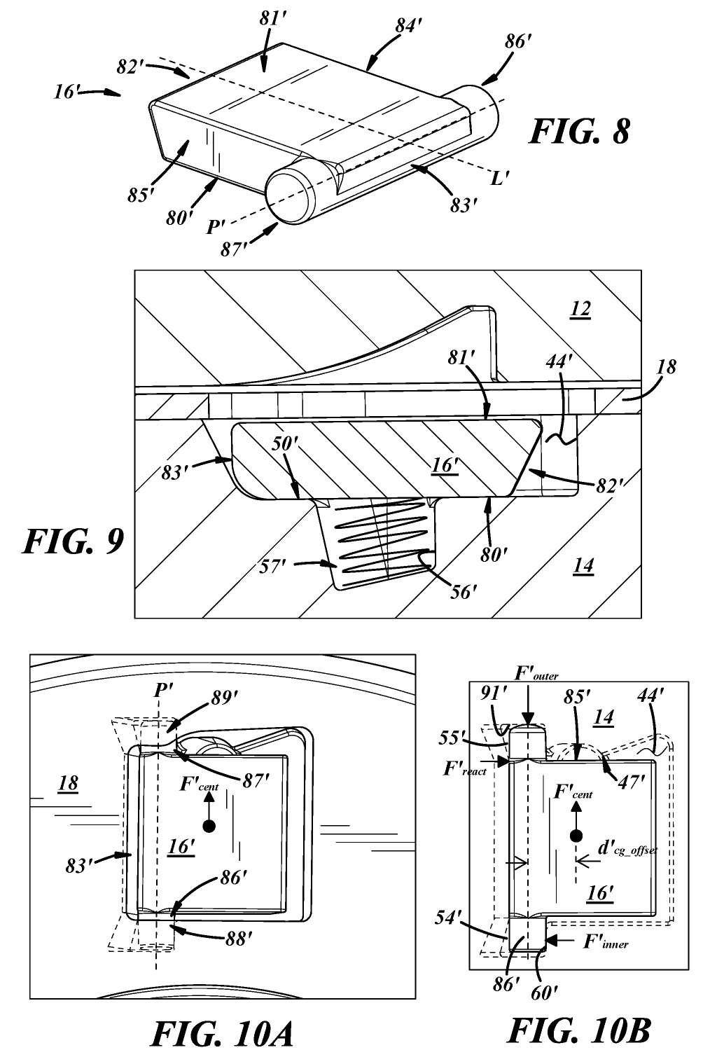

FIGS. 8-10B show another illustrative embodiment of a planar strut and portions of another planar torque-transmitting coupling. This embodiment is similar in many respects to the embodiment of FIGS. 5-7B and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

With reference to FIG. 8, the “T” strut 16’ extends along a longitudinal axis L’ and is pivotable about a pivot axis P’ that extends transversely with respect to the longitudinal axis L’. The strut 16’ includes inner and outer faces 80’, 81’, and longitudinal forward and rearward ends 82’, 83’ extending transversely between the faces 80’, 81’. The strut 16’ also includes inward and outward sides 84’, 85’ extending transversely between the faces 80’, 81’ and between the longitudinal ends 82’, 83’. The strut 16’ further includes inner and outer ears 86’, 87’ extending in a direction away from the sides 84’, 85’ and having cylindrical outer surfaces. The cylindrical outer surfaces of the inner and outer ears 86’, 87’ may be continuously cylindrical at least over circumferential portion thereof that contacts the corresponding surface(s) of the pocket plate 14.

With reference now to FIG. 9, the faces 80’, 81’ may be flat. Also, the longitudinal rearward end 83’ may have a flat portion, and an excurvate portion between the flat portion and the inner face 80’ and in conformity with the corresponding incurvate shaped surface of the strut pocket 44’ of the planar pocket plate 14. Further, the longitudinal forward end 82’ may be obliquely angled in a direction between the faces 80’, 81’, wherein an acute angle is formed by the outer face 81’ and the forward end 82’. The forward end 82’ may be flat over a predominant portion thereof but with a rounded nose that transitions the forward end 82’ to the outer face 81’. The inner face 80’ is illustrated resting on a flat portion of the bottom 50’ of the strut pocket 44’ of the planar pocket plate 14, wherein the forward end 82’ of the strut 16’ is disposed within the strut pocket 44’ and does not extend out of the strut pocket 44’, such that the strut 16’ is in its laydown position within the strut pocket 44’. FIG. 9 illustrates a deployment spring 57’ carried in the corresponding spring pocket 56’ to bias the strut 16’ in an outward direction toward the notch plate 12.

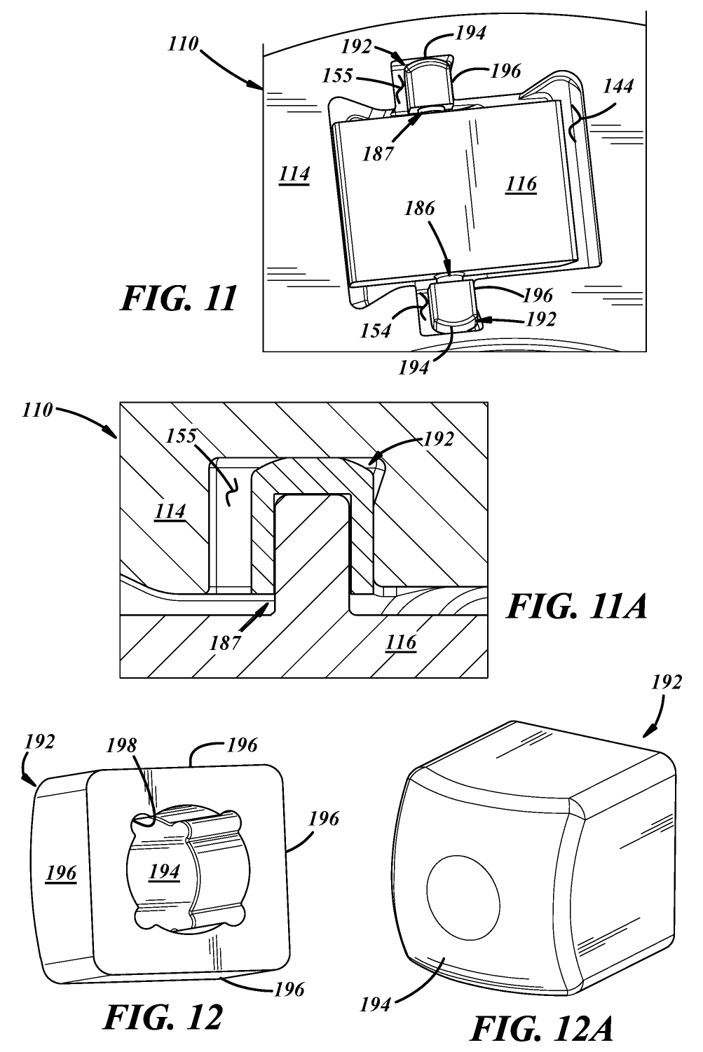

With reference now to FIG. 10A, the strut 16’ is pivotable about the pivot axis P’, which may be established by the cylindrical outer surfaces of the ears 86’, 87’ of the strut 16’. The strut ears 86’, 87’ may be located at the rearward end 83’ of the strut 16’ thereby establishing the T shape of the strut 16’. The cover plate 18 has portions 88’, 89’ corresponding to the ears 86’, 87’ to retain the ears 86’, 87’ in the ear pockets 54’, 55’ of the pocket plate 14 (FIG. 3).

With reference now to FIG. 10B, the strut 16’ is carried within the strut pocket 44’ according to one or more examples configured to address the problems identified in the background and as already addressed with reference to FIG. 7B. As a result, and with continued reference to FIG. 10B, when the pocket plate 14 is rotating, the strut 16’ experiences a centrifugal force F’_centrifugal pushing the strut 16’ radially outward. The strut 16’ is retained in a radially outward direction by an outer force F’_outer at the tip of the outer ear 87’. An offset distance d’_cg_offset between a center of gravity (black dot) of the strut 16’ and a reaction point between the tip of the outer ear 87’ and a corresponding side 91’ of the outer ear pocket 55’, creates a torsional moment on the strut 16’ that is reacted by an inner force F’_inner on the inner ear 86’ at a corresponding forward end surface 60’ of the inner ear pocket 54’ that prevents the outward side 85’ of the strut 16 from contacting the outer side 47’ of the strut pocket 44’. Additionally, but less importantly, there is a lateral reaction force F’_reaction that may take several forms, such as a normal contact force (as shown) at a radially outer rear location on the strut 16’, or a frictional force (not shown) at the reaction point between the tip of the outer ear 87’ and the corresponding side 91’ of the outer ear pocket 55’ or, less desirably, a normal contact force (not shown) at a rear of the outer ear 87’.

FIGS. 11 and 11A illustrate fragmentary portions of another illustrative embodiment of a planar torque-transmitting coupling 110. This embodiment is similar in many respects to the embodiment of FIGS. 1-10B and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

With reference to FIGS. 11 and 11A, the coupling 110 includes a planar pocket plate 114, a planar strut 116 carried by the planar pocket plate 114 in a strut pocket 144 (FIG. 11) thereof and having inner and outer ears 186 (FIG. 11), 187, and ear sleeves 192 carried on the ears 186 (FIG. 11), 187 of the planar strut 116 and carried in corresponding inner and outer ear pockets 154 (FIG. 11), 155 of the planar pocket plate 114. The ear pockets 154, 155 may be substantially similar to the ear pockets 54, 55 of the planar pocket plate 14 of FIGS. 7A and 7B, except that the ear pockets 154, 155 may be wider in a circumferential direction. The ears 186, 187 may be substantially similar to the ears 86, 87 of the planar strut 16 of FIGS. 7A and 7B, except that the ears 186, 187 may be of smaller outer diameter and may be shorter in a radial dimension.

With additional reference to FIGS. 12 and 12A, the ear sleeves 192 of the illustrated embodiment include end walls 194 and sidewalls 196 extending from the end walls 194. The end walls 194 may be closed such that the ear sleeves 192 are closed-ended at one end. In other embodiments, ear sleeves could be open at both longitudinal ends thereof wherein such ear sleeves would be open-ended ear sleeves. As shown in the illustrated embodiment, the sidewalls 196 may establish a polygonal outer surface that may be orthogonal or four-sided such that the sidewalls 196 establish a rectangular shape or square shape, as illustrated, or may be triangular, or of any other suitable polygonal shape. In other embodiments, the sidewalls 196 may establish a cylindrical outer surface, or a semi-cylindrical outer surface with one or more flats in contact with corresponding surfaces of the pocket plate 114, or the like. In any event, at least one of the sidewalls 196 may be flat for flat-to-flat contact with a corresponding flat surface of the pocket plate 14.

With reference to FIG. 11, the sidewalls 196 establish the outer surfaces of exteriors of the ear sleeves 192 and are configured to contact the ear pockets 154, 155 (FIG. 11) in assembly. The sidewalls 196 also establish cylindrical inner surfaces or cylindrical bores of interiors of the ear sleeves 192 and also are configured to contact the cylindrical outer surfaces of the ears 186, 187 (FIG. 11) in assembly. The sidewalls 196 also may include vent reliefs 198 in the cylindrical inner surfaces that may be semi-cylindrical. The strut ears 186, 187 fit closely inside the interiors of the ear sleeves 192, and tips of the strut ears 186, 187 bottom out against corresponding interior surfaces of the end walls 194. Exterior surfaces of the end walls 194 may establish tips of the ear sleeves 192 (and, thus, tips of the ears/struts) and may be excurvate, e.g., rounded, crowned, or the like. The excurvate tips of the sleeves 192 may be continuously excurvate in a direction extending radially inwardly from the orthogonal outer surfaces established by the sidewalls 196. In other embodiments, at least the excurvate tips may be flat at central portions thereof and then excurvate from the flat central portions to the orthogonal outer surfaces of the sidewalls 196. In that case, the flat central portions cover no more than 50% of the size of the outer dimensions across the sidewalls of the sleeves 192.

With reference to FIG. 11, the sleeves 192 may provide more durability than may be achieved without use of the sleeves 192. The inner geometry (e.g., cylindrical bores) of the sleeves 192 match the shape of the strut ears 186, 187 and, likewise, the outer geometry (e.g., orthogonal surfaces) of the sleeves 192 match the shape of the corresponding surfaces (e.g. orthogonal or planar) of the pocket plate 114 that support the sleeves 192. This configuration eliminates a “round-on-flat” contact interface between the cylindrical strut ears 186, 187 and flat surfaces of the ear pockets 154, 155, and instead establishes a “round-on-round” contact interface between the cylindrical strut ears 186, 187 and the cylindrical bores of the sleeves 192, and a “flat-on-flat” contact interface between the flat outer surfaces of the sidewalls 196 of the sleeves 192 and the corresponding flat surfaces of the ear pockets 154, 155.

The presently disclosed couplings 10, 110 may be used in a vehicle powertrain to carry torque from a motor (internal combustion engine, or electric motor) to vehicle wheels. The couplings 10, 110 may be used as “dynamic” (e.g., both pocket and notch plates rotating) one-way-clutches (OWCs), which is useful for achieving “powershifting” (e.g., shifting gears with persistent application of torque or no “torque-hole”) in many powertrain configurations. In one particular example, a 2-speed powershifting layshaft gearbox for an electric vehicle may use the couplings 10, 110 to carry torque in first gear, and then, in a one-way-clutch mode, the couplings 10, 110 allow a powershift from first gear into second gear, for instance, when a second-gear friction pack engages and the couplings 10, 110 begin to overrun. As such, the couplings 10, 110 may be planar dynamic one-way clutches. The couplings 10, 110 also may be used as “static” (e.g., only one of the pocket or notch plates rotating) OWCs, for example, in gearboxes that use planetary gears instead of layshafts, but the presently disclosed couplings 10, 110 are primarily aimed at addressing challenges of dynamic clutch applications.

The couplings 10, 110 can be integrated into more complex clutch systems, by using a set of struts oriented in a circumferentially reverse direction, adding an actuation system to control position of one or both sets of struts, and/or any other suitable configurations. In a first example, a clutch may include a set of the struts (forward struts) oriented in a circumferentially forward direction and a set of the struts (reverse struts) oriented in a circumferentially reverse direction and an actuation system to control such reverse struts, resulting in a 2-mode clutch system with a one-way-clutch mode and a fully locked mode. This allows the clutch to also carry torque during regenerative or reverse driving. In a second example, the presently disclosed subject matter could be implemented in a pure dynamic disconnect (no OWC mode), with a forward set of struts and a reverse set of struts and a common actuation system to actuate the forward and reverse sets of struts at the same time to transition from a fully disconnected mode to a fully connected mode. In a third example, a clutch may include a set of struts added in the reverse direction and an actuation system to control both the reverse and forward struts independently, resulting in a 3-mode clutch system with a fully locked mode, a one-way-clutch mode, and a fully unlocked mode. Such a clutch system improves over the 2-mode system because the fully unlocked mode improves the durability and drag of the clutch during “overrun” motion because struts are fully disengaged in their laydown positions instead of partially deployed and bouncing off notch ramps of a notch plate. However, the 3-mode system is likely to be more costly than the 2-mode system and, therefore, the presently disclosed subject matter provides a more durable overrunning clutch design such that the 3rd mode (fully unlocked) may be eliminated.

As used in herein, the terminology “for example,” “e.g.,” “for instance,” “like,” “such as,” “comprising,” “having,” “including,” and the like, when used with a listing of one or more elements, is to be construed as open-ended, meaning that the listing does not exclude additional elements. As used herein, permissive terms like “may” and “can” are expedients merely to indicate optionality, for instance, of a disclosed embodiment, element, feature, or the like, and should not be construed as rendering indefinite any disclosure herein.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A planar torque-transmitting coupling, comprising:
a planar pocket plate including a pocket surface having a strut pocket; and
a planar strut carried in the strut pocket of the pocket surface of the planar pocket plate, and extending along a longitudinal axis and pivotable about a pivot axis transverse with respect to the longitudinal axis, and including ears that extend along the pivot axis and that have cylindrical outer surfaces.

2. The planar torque-transmitting coupling of claim 1, wherein the planar strut further includes faces,
longitudinal ends disposed transversely to the longitudinal axis and extending in a direction between the faces, and
sides extending in a direction between the faces and the longitudinal ends,
wherein the ears extend in a direction away from the sides.

3. The planar torque-transmitting coupling of claim 1, further comprising:
a planar notch plate including a notch surface having notches circumferentially spaced from one another and facing the pocket surface of the planar pocket plate, wherein the planar strut is engageable with the notches to transmit torque between the planar pocket plate and the planar notch plate;
a cover plate coupled to the planar pocket plate and including an aperture in registration with the strut pocket of the pocket surface of the planar pocket plate;
a spring corresponding to the planar strut, and carried in a spring pocket in the strut pocket of the pocket surface of the planar pocket plate to bias the planar strut toward a deployed position in engagement with the notches of the planar notch plate; and
a retainer ring coupled to the planar notch plate to retain the planar pocket plate with respect to the planar notch plate.

4. The planar torque-transmitting coupling of claim 1, wherein at least one of the ears has an excurvate tip.

5. The planar torque-transmitting coupling of claim 4, wherein the excurvate tip includes a semi-spherical tip.

6. The planar torque-transmitting coupling of claim 1, further comprising:
at least one ear sleeve carried on at least one of the ears of the planar strut, and having sidewalls establishing a cylindrical inner surface in which at least one of the cylindrical outer surfaces of the ears are carried.

7. The planar torque-transmitting coupling of claim 6, wherein the sidewalls of the ear sleeves also establish a polygonal outer surface.

8. The planar torque-transmitting coupling of claim 6, wherein at least one of the ear sleeves has an excurvate tip.

9. The planar torque-transmitting coupling of claim 1, wherein the ears of the planar strut include
a radially outer ear having a radially outer tip in contact with a corresponding outer ear bearing surface of the strut pocket to retain the planar strut in a radial direction when the planar pocket plate rotates and the planar strut experiences a centrifugal force, and
a radially inner ear having a radially inner front surface in contact with a corresponding inner ear bearing surface of the strut pocket to retain the planar strut in a torsional direction when the planar pocket plate rotates and the planar strut experiences the centrifugal force.

10. The planar torque-transmitting coupling of claim 1, wherein the strut pocket of the planar pocket plate is part of a circumferential array of strut pockets circumferentially spaced from one another.

11. The planar torque-transmitting coupling of claim 1, wherein the strut pocket is a teeter-totter strut pocket or a T strut pocket.

12. A torque-transmitting coupling planar strut pivotable about a pivot axis, and comprising:
a body; and
ears extending outwardly from the body and having cylindrical outer surfaces establishing the pivot axis.

13. The torque-transmitting coupling planar strut of claim 12, wherein the body includes:
a longitudinal axis, wherein the pivot axis is transverse to the longitudinal axis;
faces;
longitudinal ends disposed transversely to the longitudinal axis and extending in a direction between the faces; and
sides extending in a direction between the faces and the longitudinal ends.

14. The torque-transmitting coupling planar strut of claim 12, wherein at least one of the ears has an excurvate tip.

15. The torque-transmitting coupling planar strut of claim 14, wherein the excurvate tip includes a semi-spherical tip.

16. The torque-transmitting coupling planar strut of claim 12, further comprising:
at least one ear sleeve carried on at least one of the ears and having sidewalls establishing cylindrical inner surfaces in which the ears are carried.

17. The torque-transmitting coupling planar strut of claim 16, wherein the sidewalls of the ear sleeves also establish a polygonal outer surface.

18. The torque-transmitting coupling planar strut of claim 16, wherein at least one of the ear sleeves has an excurvate tip.

19. A clutch strut ear sleeve, comprising:
sidewalls establishing a cylindrical inner surface.

20. The clutch strut ear sleeve of claim 19, further comprising a closed end wall from which the sidewalls extend, and wherein the sidewalls also establish a polygonal outer surface.

21. A planar torque-transmitting coupling, comprising:
a planar pocket plate including a pocket surface having a strut pocket;
a planar strut carried in the strut pocket of the pocket surface of the planar pocket plate, and extending along a longitudinal axis and pivotable about a pivot axis transverse with respect to the longitudinal axis, and including ears that extend along the pivot axis and that have cylindrical outer surfaces, wherein the ears of the planar strut include
a radially outer ear having a radially outer tip in contact with a corresponding outer ear bearing surface of the strut pocket to retain the planar strut in a radial direction when the planar pocket plate rotates and the planar strut experiences a centrifugal force, and
a radially inner ear having a radially inner front surface in contact with a corresponding inner ear bearing surface of the strut pocket to retain the planar strut in a torsional direction when the planar pocket plate rotates and the planar strut experiences the centrifugal force,
wherein at least one of the ears has an excurvate tip; and
a planar notch plate including a notch surface having notches circumferentially spaced from one another and facing the pocket surface of the planar pocket plate, wherein the planar strut is engageable with the notches to transmit torque between the planar pocket plate and the planar notch plate.

22. A planar torque-transmitting coupling, comprising:
a planar pocket plate including a pocket surface having a strut pocket;
a planar strut carried in the strut pocket of the pocket surface of the planar pocket plate, and extending along a longitudinal axis and pivotable about a pivot axis transverse with respect to the longitudinal axis, and including ears that extend along the pivot axis and that have cylindrical outer surfaces,
at least one ear sleeve carried on at least one of the ears of the planar strut, and having sidewalls establishing a cylindrical inner surface in which at least one of the cylindrical outer surfaces of the ears are carried, and including
a radially outer ear sleeve having a radially outer tip in contact with a corresponding outer ear bearing surface of the strut pocket to retain the planar strut in a radial direction when the planar pocket plate rotates and the planar strut experiences a centrifugal force, and
a radially inner ear sleeve having a radially inner front surface in contact with a corresponding inner ear bearing surface of the strut pocket to retain the planar strut in a torsional direction when the planar pocket plate rotates and the planar strut experiences the centrifugal force,
wherein at least one of the at least one ear sleeve has an excurvate tip; and
a planar notch plate including a notch surface having notches circumferentially spaced from one another and facing the pocket surface of the planar pocket plate, wherein the planar strut is engageable with the notches to transmit torque between the planar pocket plate and the planar notch plate.
